(19) United States
(12) Patent Application Publication
(10) Pub. No.: US 2009/0116604 A1
(43) Pub. Date: May 7, 2009

(54) Machine for producing flow of Isotopic fuel through a material

(76) Inventor: Mitchell R. Swartz, Weston, MA (US)

Correspondence Address: Mitchell R. Swartz, ScD, EE, MD, 16 Pembroke Road, Weston, MA, 02493, US

(21) Appl. No.: 12/154,712

(22) Filed: May 28, 2008

Related U.S. Application Data
(63) Continuation-in-part of application No. 07/339,976, filed on Apr. 18, 1989, now abandoned.

(51) Int. Cl. G21B 1/00

(52) U.S. Cl. 376/100

(57) ABSTRACT

A machine for producing flow of isotopic fuel through a material with a wire or rod anode which does not corrode, such as platinum, a solution, such as deuterium oxide (D2O), in which are immersed the electrodes, anode and cathode, which will provide the isotopic fuel (hydrogen or deuterons) and load the cathode, a power supply capable of apply an electric field intensity between the electrodes, able to produce loading and intraelectrode flux of the isotopic fuel, with a potential in the range of 4 to 4000 volts, a cathode of helical shape, long axis parallel to the anode, of palladium, able to load with the isotopic fuel to support intraelectrode flux of the isotopic fuel, a ratio of diameters between the full width of the helical wound cathode and the anode of 4 to 1000, a distance between the electrodes, adjusted to create direct loading, and over each portion of the helical cathode, closest to the anode, over a two dimensional angle of 45 to 130 degrees.

This invention relates to energy production, energy storage, and energy utilization of hydrogen-loaded, and deuteron-loaded metals and other materials, and has additional relevant to solid state physics, quantum optics, and chemistry.

In addition, the invention relates to heat production, fusion reactions, transmutation, and flux of hydrogen isotopes through hydrogen-loaded metals and other materials, such as palladium, nickel, titanium, cerium, lanthanum, niobium, tantalum, thorium, vanadium, zirconium, and their alloys and composites. The invention has relevance to electrolytically hydrogen-loaded materials, pressure loaded materials, and those materials which are “preloaded” with protons or deuterons already in place as an alloy (e.g. PdDₓ, TiDₓ). The present invention is also applicable to materials which do not exhibit excess heat (observable heat beyond that of a joule thermal control).

By way of background and to place reasonable limits on the size of this disclosure, the following references and articles may be used by way of background material and to supplement this specification.

### OTHER PATENTS AND PUBLICATIONS

| Patents Cited | |
|---|---|
| Swartz, M.R. | SN: 07/339,976 |
| Swartz, M.R. | SN: 10/761,536 |
| Swartz, M.R. | SN: 09/750,480 |
| Swartz, M.R. | SN: 07/760,970; Continuation SN: 09/750,765 |
| Swartz, M.R. | SN: 08/406,457 |
| Swartz, M.R. | SN: 10/646,143 Filed: Aug. 23, 2003 |

D R Smith, J B Pendry, MCK Wiltshire, Metamaterials and Negative Refractive Index, Science, 2004—sciencemag.org.
Swartz. M., G. Verner, “Excess Heat from Low Electrical Conductivity Heavy Water Spiral-Wound Pd/D2O/Pt and Pd/D2O—PdCl2/Pt Devices”, Condensed Matter Nuclear Science, Proceedings of ICCF-10, eds. Peter L. Hagelstein, Scott, R. Chubb, World Scientific Publishing, NJ, ISBN 981-256-564-6, Pages 29-44; 45-54, and 213-226 (2006).
Swartz, M, “Phusons in Nuclear Reactions in Solids”, Fusion Technology, 31, 228-236 (1997).
A. Von Hippel, “Dielectric Materials and Applications”, MIT Press, Cambridge (1954). http://www.fen.bilkent.edu.tr/˜ozbay/Papers/60-02apl-LHMbayndir.pdf
Swartz. M., “Can a Pd/D2O/Pt Device Be Made Portable to Demonstrate the Optimal Operating Point?”, ICCF-10 (Camb. MA), Proceedings of ICCF-10, (2003).
Swartz, M, “Quasi-One-Dimensional Model of Electrochemical Loading of Isotopic Fuel into a Metal”, Fusion Technology, 22, 2, 296-300 (1992).
Swartz, M, “Isotopic Fuel Loading Coupled to Reactions at an Electrode”, Fusion Technology, 26, 4T, 74-77 (1994).
Swartz, M, “Consistency of the Biphasic Nature of Excess Enthalpy in Solid State Anomalous Phenomena with the Quasi-1-Dimensional Model of Isotope Loading into a Material”, Fusion Technology, 31, 63-74 (1997).

### BACKGROUND

In the following, the preferred embodiment of the present invention involves a palladium electrode which becomes fully loaded (filled) with deuterons which are obtained from deuterium oxide (heavy water) in which the electrode is positioned. Loading refers to the volume (ratio) filling of the palladium with the lighter, isotopic hydrogen, which in the general preferred embodiment are deuterons. Successful production of the desired reactions is required for optimal performance of these systems, and for the desired reactions there must be full filling (“loading”) of the palladium electrode by the deuterons, much as a sponge fills with water.

The loading is driven by an applied electric field intensity. Originating in the heavy water (D₂O), deuterons first attach to the surface of the palladium cathode, and then many enter (“are loaded”) into the palladium lattice. To better control these systems, Swartz (Ser. No 07/339,976, Apr. 18, 1989, a specification pending before the Patent Office) taught the use of a controlled current source rather then a battery. The controlled current source precisely controls the loading, of the metal from the electrolytic solution. Insufficient current densities are subthreshold for the desired reactions, and when the voltage becomes too high, then undesirable low dielectric constant layers (large bubble gases) develop in front of the cathode.

Loading Flux

There are several crucial electrical and material factors which effect both the loading and the rate of loading. These include palladium and heavy water solution purity, and the prehistory and achieved loading of the palladium lattice to be filled. The loading flux of hydrogen, here deuterons into the bulk volume of the palladium cathode, is fundamental to the entire understanding of these phenomena. Simply put, unfortunately, not all of the isotopic material of interest enters the metal. The loading flux divided by the concentration of deuterons is the first order loading flux rate.

How can the first order loading flux of hydrogen, k_{c} [units of cm/sec] be determined? The electrical current does not, and cannot, reflect the quantity of deuterons entering the palladium lattice (related to the loading flux). A reference electrode in the deuteron solution at equilibrium measures potentials (associated with the Nernst equation), but it, too, gives no information regarding the loading flux rate. Furthermore, during the reactions, the system may not even be at equilibrium.

What does reflect that quantity of entering deuterons is mathematical analysis where the precise loading flux of deuterons entering into the bulk palladium volume is distinguished from the gas evolving flux [Ser. No. 07/339,976, Swartz (92), Swartz (94), Swartz (97A), Swartz (00)]. Reference is made to said application and published articles with a description of loading, materials, methods, and terms discussed below which may be employed in the discussion and claims the present application. The cited references are incorporated as if included herein.

The quasi-1-dimensional model of deuteron loading describes the situation external to the cathode. The application of the power source creates an applied electric field intensity which produces cation flow towards the cathode. There results in the near cathode solution a buildup of deuterons and a low dielectric constant (gas bubble) layer. The electric field distribution is altered as the solution and system each respond with complex conduction and polarization phenomena. Ionic drift, secondary space charge polarization, propagation of solvated deuterons, deuterons in clathrates, and L- and D-deuteron defects with their ferroelectric inscription in the heavy water, and the formation low dielectric constant bubbles abutting the cathode are the minimum expected. The double layer between the solution and the metal is created both by the cathode fall of ions and other polarization reactions.

In the absence of solution convection, molecular flux (J_{D}) results from both diffusion down concentration gradients and electrophoretic drift from an applied electric potential.

A very important result is heralded by the quasi-1-dimensional analysis of loading and the Einstein relation which indicates that the loading rate is a competing process of gas loss. Gas loss controls loading inversely. Deuteron availability (secondary to the applied electric field) to the palladium lattice is basically at odds with gas evolution at the cathode. Therefore, the desired reactions are quenched by electrolysis [Swartz (92), Swartz (97A), Swartz (00), Ser. No. 08/406,457].

The second important result of this analysis is that both competitive gas evolving reactions at the metal electrode surface and the ratio of the applied electric field energy to thermal energy [k_{B}*T] are decisive in controlling the loading flux of the palladium by deuterons.

The third important result obtained from the quasi-1-dimensional analysis of loading is that codeposition offers rapid loading rates [Swartz (97B), Swartz (Ser. No. 07/339,976)] using palladium salts located in the solution “and the means to cathodically codeposit said materials directly onto a cathode” for purposes of achieving high local and regional loading.

For more than 19 years, lattice assisted nuclear reactions (LANR) in the solid state have been increasingly more successful, more reproducible, and have been examined with diagnostics, spectroscopy, and calorimetry, each of which have led to greater understanding of the roles of loading, dislocations, contamination, and other factors, some of which are either the sine qua non, and others terminate, successful function of LANR-active devices. In addition to inactive samples of potentially-loaded material (detected and ruled out such as by the invention described in Ser. No. 08/406,457), other reasons for failure to achieve the desired results include insufficient loading of the active sample (Swartz Ser. No. 07/339,976), the failure to monitor said loading (Ser. No. 09/750,480), and the failure to activate [Ser. No. 07/339,976 and Ser. No. 09/750,765]. Increased thermal conductivity from water vapor above the system has a sign such that if it does occur, it will make the detected excess heats a lower limit. Recombination has been reported to levels of milliwatts but is not a problem here for several reasons.

First, this is a closed system with collection of all gas and recovery of the energy.

Second, and most importantly, any error due to recombination is definitively ruled out by taking the input power as V*I, defined by Poiynting's vector.

Third, many of the excess power levels are orders of magnitude greater than those provided by recombination. Silicate deposition has been hypothesized to create a false positive of “excess heat”, however elementary analysis reveals that it can provide heat but not excess heat under normal conditions, and furthermore silicates are not present here. The result of the electrical resistance effects by the leads is important, but in any case, could not account for the observed calibrated excess heat in these experiments. This is because the contacts and leads are measured for these experiments, and their resistances are arranged to be much less compared to the ohmic controls. They are explicitly included in the derivations as discussed below. Errors in power input calculations are significantly reduced by sampling at least at 10-100 Hertz, using precision current sources, and indicators when any rail voltage is reached, etc., as discussed in the cited references.

### HISTORY OF TECHNOLOGY

Research has led to a new kind of Pd/D2O/Pt, Pd/D2O/Au, Pd/PdCl2-D2O/Pt engineered structure that has energy gain and fairly good reproducibility ('143). When specific requirements of preparation of the tightly wound Pd helices are used, along with a low paramagnetic heavy water solution, and control of location of both the Phusor structure and its optimal operating point (OOP), the Phusors produce energy gains of 1.2 to more than ˜3.5, with excess power gains of watts

Palladium D2O platinum devices demonstrate a critical input electrical current density in the range of ˜1.3 to 5.6 milliamperes/cm², and a possible activation energy of ˜60.7 kilojoules/mole. This activation energy is consistent with the teachings of Ser. No. 07/339,976 and Swartz (92). A maximum in performance was reported by Swartz (1995), where the peak was for the power gain curve versus input power. In Ser. No. 08/406,457, the invention used “increasing through a series of at least three incremental steps the electric power drive conditions of said electrical circuit” to determine that optimal operating point. FIG. 20 is similarly a maximum but of the excess heat rather than the power gain. FIG. 20 proves that this invention goes even further than previous one, with a clearly defined region of superior performance delivered the maximum excess heat on an energy efficiency basis.

To better control these systems, Swartz (Ser. No. 07/339,976) taught the use of codeposition of the metal to be loaded and separate subsystems to increase the efficiency of heat collection and electricity generation. '43 taught a new and improved codeposition solution composition, a new and improved method of heat collection and obtaining electricity with superior integration of the subsystems, among other things.

### PRIOR TECHNOLOGY

LANR materials and devices, like metamaterial behavior, resist conventional thinking but they continue to produce experimental hard results, defying previous expectations. Regarding LANR, there have been two decades of deuteron-loaded electrodes producing releases of energy, far beyond what was applied, and beyond the chemical energies even available by including all reactants and their containers. With LANR, because in cases where it has been carefully sought, commensurate de novo helium-4 has been detected at production levels expected for the nuclear energies involved, when heavy water to provide deuterons has been loaded into the palladium cathodes to achieve D/Pd ratios of 0.85 or greater, along with requisite activation energy, maintenance of structural lattice, with phonon support. Thus, these reactions do appear to be nuclear. Furthermore, they are becoming more reproducible, controllable, and of higher power density.

Success of LANR experiments has multiple factors. Several technologies have made improvements in the number of positive results and degree of success of LANR which have previously been, simply put, very difficult to achieve. Examples include the need for significant loading and deuteron flux, and the need to electrically drive the system at, or near, the optimum operating point (OOP; that point along the input power axis where driving the LANR device yields maximum output of product).

The OOP curves (“manifolds”) are seen by analyzing the results of a LANR experiment by input electrical power. OOPs have been discovered to have wide generality for LANR reactions, and the existence has elucidated several uniformities of the otherwise disparate field. It has made what has initially appeared as non-reproducibility, more ordered by clearly organizing the results. By control of the OOP, the appearance of unique isotropic bubbling in successful LANR-active Pd/D2O/Pt, Pd/D2O/Au, and other devices has predicted, and been correlated with, the appearance of fairly reproducible excess heat. This discovery has been confirmed multiple ways which include: heat flow measurement, calorimetry, electrical and mechanical energy conversion devices, and with controls including noise measurement, internal and external ohmic controls, and even dual calorimetry.

Metamaterials defy previous expectations by offering surprising new characteristics, such as negative refractive index materials, and other phenomena which were previously “ruled” to be impossible. Past reports of excess energy and emissions from lattice assisted devices and systems were similarly previously felt to be impossible but there, too, the growing experimental evidence supports that LANR is real. Thus, metamaterials, like devices which exhibit LANR, demonstrate properties not previously observed or expected. Structurally-shaped metamaterials show characteristic behavior far beyond normal material responses expected.

Electrical permittivity and magnetic permeability are both positive in nature. In such normal materials, previous physics taught the use of the right-handed rule for electromagnetic (light) propagation, with the energy (Poynting vector) traveling in the same direction. However, if a material is a “left-handed material” (LHM), then it has a negative (refractive) index material (NIM), and other unusual things occur. In left-handed materials (LHM), both the dielectric permittivity and permeability are negative, and the phase and group velocities of light propagate in opposite directions.

This has been observed for metamaterials with their left-handed properties where the handedness makes light propagate opposite the Poynting vector (energy flows), and enables reversal of the expected Doppler shift, and causes Cherenkov radiation, normally emitted light in the forward direction, to be emitted backwards.

### DEFICIENCY IN PRIOR TECHNOLOGY

Present technologies are lacking because intra-electrode palladium flux is what is necessary to produce the desired reactions, and that such a flux is often missed in competing systems, based on the teachings here, and a review of the poorer performance of some competing systems. This has been confirmed recently in both transmutation and excess power gain experiments.

There is always a need to improve excess power gain and product production and to make LANR devices attain maximum efficiency. Although many hundreds of designs have been tried, only the present invention resolves and teaches why some are superior. This invention maximizes the potential of Phusors by teaching the best arrangement for a well-engineered scientifically-designed LANR system. Despite trying scores of variations of electrode arrangements and materials, until this discovery, it was not clear exactly why this uniquely shaped cathodic structure has been so functionally useful, or how to maximize its function. Hypotheses including cold working of the metal, electrode preparation, and contamination have not accounted for the Phusor success. This invention changes all that, proven by close meticulous examination of the actual electric field intensity distribution.

### ADVANTAGES AND QUALITIES OF THE PRESENT INVENTION

The invention described by the above-entitled application has many advantages over present apparatus, processes, and systems.

The following advantages are discussed without demeaning any of the others.

The present invention is a significant improvement of previous technologies.

One object of the invention is to improve efficiency of heat production.

Another object is to increase reproducibility and power gain of systems.

A further object of the invention is to improve deuteron flow within the electrode.

Another object of the invention is to improve loading of an electrode and to maintain flux through said electrode.

Yet another object is to carry out control, geometry and stereo-constellation which become as important as the materials, themselves.

A still further object of the invention is to facilitates the creation of the requisite electric field intensity and its distribution, and the secondary deuteron flux requisite, for more successful operation of devices involving loading.

Another object of the invention is to create an entire spectrum of new devices using controlled intraelectrode flow.

Another object of the invention is to provide a means to increase intraelectrode hydrogen, or deuteron, flow.

Another object of the invention is to increase the heat generated by devices which load metals with either hydrogen or deuterons.

### BRIEF DESCRIPTION OF THE DRAWINGS

FIG. 1 is a 2-Dimensional vector electric field distribution for two parallel, infinitely long, electrodes (anode at the top, and cathode wire) is shown for three inter-electrode distances. The colors show several arbitrary thresholds in electric field intensity.

FIG. 2 is a 2-Dimensional vector electric field distribution for the wire-Phusor (or cylinder) system for three different sizes of Phusor radius, and varying inter-electrode distances. The anode is at the top, and the cathode Phusor is below it. The colors show several arbitrary thresholds in electric field intensity.

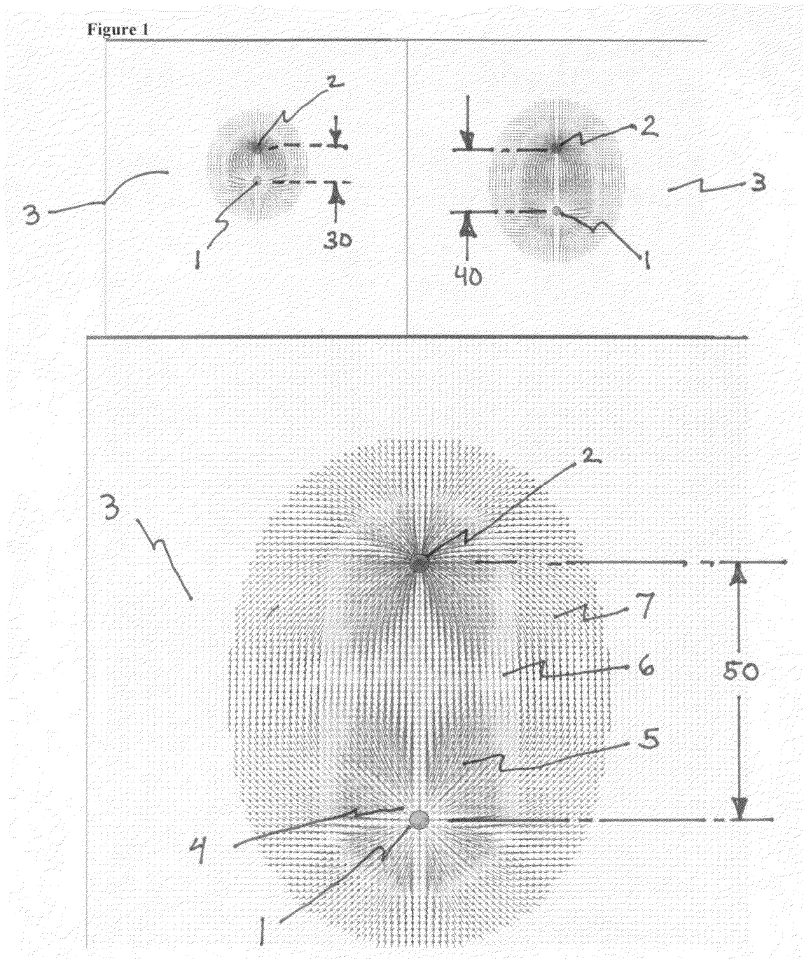

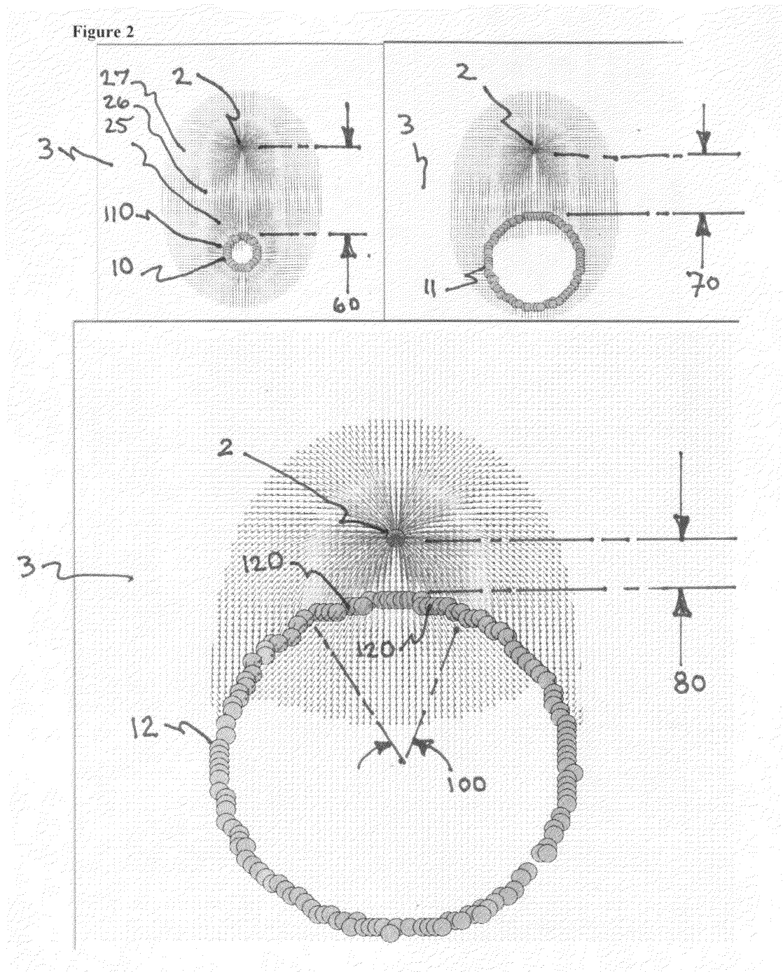

These figures demonstrate that the 2-Dimensional vector electric field distributions vary greatly between the wire-wire system (FIG. 1) and the wire-Phusor or wire-cylinder system (FIG. 2).

### SUMMARY OF THE INVENTION

A machine for producing flow of isotopic fuel through a material comprising: a wire or rod anode which does not corrode, such as platinum, a solution, such as deuterium oxide (D2O), in which are immersed the electrodes, anode and cathode, which will provide the isotopic fuel (hydrogen or deuterons) and load the cathode, a power supply capable of apply an electric field intensity between the electrodes, able to produce loading and intraelectrode flux of the isotopic fuel, with a potential in the range of 4 to 4000 volts, a cathode of helical shape, long axis parallel to the anode, of palladium, able to load with the isotopic fuel to support intraelectrode flux of said isotopic fuel, a ratio of diameters between the full width of the helical wound cathode and the anode of 4 to 1000, a distance between the electrodes, adjusted to create direct loading, and over each portion of the helical cathode, closest to the anode, over a two dimensional angle of 45 to 130 degrees.

This patent is a continuation-in-part which teaches how Phusor devices, which can provide excess nuclear energies beyond those energies applied, in the amounts of hundreds of thousands of joules per day, can be prepared to maximize output by further engineering of it as a structural metamaterials. Under this preferred embodiment, and with this further invention, these Phusors in their LANR system deliver performance beyond that expected by the materials used, and there are geometric, metamaterial, issues, which create this dichotomy with other devices.

### FIELD OF THE INVENTION

This invention relates to energy production, and more particularly to a machine for producing flow of isotopic fuel, such as hydrogen or deuterons, through a material, such as palladium which is loaded with that isotopic fuel. This invention is of great utility to researchers of LANR systems, those working with hydrogen loading devices, and solid state electro-physicists, and those investigating or design devices using such intraelectrode flow.

### DETAILED DESCRIPTION OF THE INVENTION

With this invention, Phusors are transformed to functional metamaterials. Their structure, as a right-handed helix electrode, interacts with the applied electrical field intensity. With this invention, the desired reactions are facilitated, using conventional physics and electrical engineering in a novel and non-obvious way. Furthermore, the utility is clear because the output is increased, and therefore the desired products will be maximized (heat, electricity through converters, elemental change).

As a metamaterial, the uniqueness of Phusor geometry enables nuclear reactions to occur. In this setup, this happens not only because these devices are fully loaded palladium, but also because the structural geometry of the electrode itself interacts with the applied electric field intensity to produce a net continuous flux of deuterons moving through the palladium.

What is also relevant to those in the material science field is this example of a metastructure, electrode-electrolyte (each with dual lattices within them; palladium, deuteron, and oxygen, deuteron, respectively) of a composite material which then gives rise to functionality beyond that of the material properties alone.

This invention teaches, and shows by ab initio numerical simulation that this invention is a metamaterial, and that the electrical field intensity near the Phusor system drives flux of deuterons through the metal, resulting in a quite different performance than conventional electrochemistry involving simpler structures, such as wires. The present report shows the results of the vectorial Laplace calculations of the electric field intensity distributions between a coiled electrode and a vertical wire in a solution indicating a pivotal key which rate-limits critical success in LANR reactions.

The results of this preliminary electrostatic analysis has shown that two non-equilibrium deuteron flows arise from the spatial distribution of the electric field intensity (E-field) distribution located between the platinum anode and palladium spiral/cylindrical cathode. A rather unique zeroth order electric field (E-field) distribution results from the Phusor cylindrical geometry and the placement of the opposing anode, so that there are two deuteron fluxes (flows) created within the cathode.

There is a non-equilibrium deuteron loading flux through the solution, and then a second non-equilibrium deuteron flux through the metal. The use of these fluxes (as discussed in the Q1D model of loading, and thereafter) is the important factor which—thought previously less well recognized—has enabled and resulted in demonstrations of excess heat at MIT. It is also likely that these present findings corroborate our earlier reports of asymmetric bubbling, heralding anisotropic non-equilibrium deuteron flux, at only one side of the metallic loaded palladium cathode, which precedes LANR success.

The understanding of engineering these flows are critical. First, the present invention teaches a unique approach from a stereoconstellation point of view (and not merely a material or engineering difference) able to help produce more successful, more efficient, LANR systems.

Second, another important point is that there are now both experimental and theoretical reasons demonstrating a non-isotropic distribution of electric field at the cathode with the Phusor arrangement. The unique E-Field intensity distribution results from the Phusor cylindrical geometry. The pivotal, important driving force is shown to be non-equilibrium deuteron loading flux through the loaded palladium.

Third, by contrast, lack of understanding of this intraelectrode deuteron flow may contribute to some of the failures in conventional LANR systems reported, although as in the past other patterns of failure, including high electrical conductivity of the solution, cathodic physical form, and geometric placement reasons must also be considered.

These conclusions may be somewhat of a first, by extending material and engineering control of LANR reactions to structure of the electrodes as well. Thus, the Phusor under the arrangement taught in the present invention becomes a metamaterial, and with the present teachings, LANR reactions, already controlled by input electrical power through OOPs, now have further precise control by selected design of the geometry of the system, to make a metamaterial.

Consider first the field distribution around the anode, then the Phusor with consideration of the spiral and the small electrical conductivity of the solution relative to its surroundings. This consists of the cylinder anode, cylindrical spiral cathode, and probably several metallic (but isolated by electrically insulating materials) rods collecting data. Electric field intensity computations were made using Laplace's equation and numerical analysis for a variety of geometries. This was done by treating the most general case of an infinitely long, spiral palladium Phusor, which in this gendanken experiment is placed in a vertical and parallel position, relative to the infinitely long platinum anode. Electrodes on two sides are used to apply an electric field intensity and current density to a region with this infinite cylindrical geometry. It is, therefore, in this inside region, outside the cylindrical spiral Phusor, but between the electrodes where the fields should be first approximated.

In this case, it is the solution into which the electrodes are immersed which is relatively electrically insulating. The electrodes are electrically conducting, and they impose an approximate boundary condition so that there is a negligible (zero, if perfectly conductive) tangential electrical field intensity at the most superficial portions of the spiral Phusor. This considers, therefore, a normal current density, and hence the radial derivative of the potential at the surfaces of the electrodes. There are difficulties in this analysis because no closed-form solution probably exists for the polarizability of platinum anodic cylinder in combination with the parallel spiral cathode of palladium. Furthermore, in this case, the polarizing electrode system is having its cathode undergo hydrogen loading, with its own internal polarization, even as within the system the charges bind countercharge at the surfaces, which are themselves interacting with a complex electrochemical solution located between the two electrodes and which also bathes the spiral cathode internally. Ignoring for the moment the limitations, each section within the volume has its own polarizability, thermally conductive properties, and will further change properties and possibly position as the result of heating and the Bernard instability.

And so for this case, the electric field intensity distribution had to be calculated numerically. The numerical analysis modeled the complex continuum electrodynamic problem involving mass, charge, and thermal transfer, using a more elementary electrostatic superposition technique to derive a qualitative two dimensional result to zeroth order. To derive the electric field intensity distribution, the Phusor is modeled as a ring of cylindrical symmetry, and infinite length, using Laplace's equation, cylindrical coordinates both near the Phusor and the wire, and boundary conditions, to derive the unique answer. There are limitations because in this simple model, it was assumed that the dielectric relaxation times were past, that there was initial equal distribution of charge over the Phusor electrode metal surface, and convection, mass and energy transfer, thermal issues, secondary re-polarizations, and electric field intensity redistributions were ignored.

Turning Now to the Figures.

Attention is directed to the derived zeroth-order electric field distributions seen in FIGS. 1 and 2. The figures show only the core, the heat generating, or product generating, core of a LANR system. In this close-up, the entire volume (here as an area in cross-section) are filled with solution and electrodes.

The heavy water reaction container containing the electrodes with feedthroughs, and which enables gases [D2 and O2], D2O, and heat to pass while maintaining electrical contact with hermetic seal is not shown. A vertical wall within the heavy water reaction container may be used to separate D2 and O2, as they are generated, on the cathode and anode, respectively.

A solution is used to immerse the electrodes, and to provide the isotopic fuel (hydrogen or deuterons) with which to load the metal, such as deuterium oxide (D2O). In the preferred embodiment, the solution, in the reaction container, consisting of very low electrical conductivity heavy water, such as the low paramagnetic, low conductivity deuterium oxide, 99.99%, [Cambridge Isotope Laboratories, Andover Mass.]. Such very pure heavy water minimizes the unwanted reactions of electrolysis. If the ultrapure heavy water is unavailable, 99.99% pure D₂O can also be used but at a loss of efficiency. The heavy water is hygroscopic and must be physically isolated from the air. In other variations, other materials might be added such as LiOD, or codepositional solutions, or a gel or solid.

The cathode might also be a member of the group consisting of palladium, titanium, and nickel, and niobium, or other Group VIII or transition metal cathode as an alternative loaded metal

The anode is the site of electrical oxidation, and a wire or rod anode, which does not corrode, of platinum in the preferred embodiment, is used. Gold as the anode is an alternative.

The spiral-wound palladium cathode is the site of electrical reduction, and is physically the location where gaseous molecular deuterium (heavy hydrogen) is formed de novo. The cathode is of palladium, 1 mm diameter in the preferred embodiment, and wound into a right-handed helical shape. It is oriented with the axis of the helix oriented parallel to the axis of the anode. For the palladium cathodes in the preferred embodiment of the heavy water system, the wound cathode is made from palladium wire, 1.0 mm diameter, 99.98+% (metals basis), JET Energy, Wellesley, Mass.].

In the preferred embodiment, both wire electrodes are wound into spiral shape. Other shapes can be used, as long as the features taught herein are included. All wires and eventual spiral-wound electrodes must be handled, and assemblies fashioned, using aseptic techniques so as to minimize contamination.

The heavy water loading subsystem consists of an electrical power source connected, in the preferred embodiment, to two electrodes comprising an anode made of platinum and a cathode made of palladium. A power supply capable of applying an electric field intensity between the electrodes, able to reach a potential in the range of 2 through several thousand volts. Electrical voltage sources include the LAMBDA 340A, LLS3040, LG531, and the HP722AR. The HP/Harrison 6525A, Nobatron DCR-150, and Fluke 412B are used to obtain transsample potentials of voltages up to 3000 volts. Electrical currents are derived from electrical current sources [e.g. Keithley 225, JET Technology 1280 and 1200 Electrophotodynamic Drivers, HP 6177c, Electronic Development Corporation CR-100R (NY)]. They are also measured to confirm the outputs (+/−1% accuracy). Electrical potentials are measured with high performance units [at least +1-0.5% accuracy, such as Keithley 610C Electrometer, Keithley 160B microvoltmeter, 178 or 179 digital multimeter, Dana Electronics 5900 multimeter, Fluke 8350A multimeter, or HP 412 vacuum tube voltmeter, 3465A or 3490A voltmeters].

In the preferred embodiment, volume of the heavy water solution is 30 cubic centimeters. In the preferred embodiment, the active area of the palladium cathode is 6.7 square centimeters, the number of turns is 12, the active volume is 0.17 cm³. In the preferred embodiment, the platinum anode has 6 turns, an active area of 3 cm², and an active volume of 0.077 cm³.

The system is designed to interact with the applied electric field intensity, and solution, to load with the isotopic fuel, and to enable flux of the loaded isotopic fuel (hydrogen or deuterons) through the metal.

The ratio of diameters of the width of the helical cathode which loads with the isotopic fuel to the width of the anode is in the range of 5 to 200.

The distance between the electrodes is adjusted to create a direct loading, secondary to the applied electric field intensity, in those portions of the helix which are closest to the wire anode extending over an two dimensional angle of 45 through 130 degrees.

Turning first to FIG. 1. There is shown the electric field intensity for two parallel, infinitely long, electrodes (anode and cathode). In this case, a spiral wound Phusor with its helical structure is not used. Instead, convention wires are used. What is shown is the cross-section through the two electrodes so that the wires only appear as two circles. The electric field intensity distribution is shown for three inter-electrode distances.

Attention was directed to the three distributions of the electric field intensity distribution which are shown in two dimensions, in the figure. The three electric field intensity distributions are shown in two dimensions, and in a plane which is located perpendicular to the direction of the electrodes (labeled 1 for the cathode, and labeled 2 for the anode) which are mainly oriented in a direction coming out of the figure.

The solution, into which the two electrodes are submersed (labeled 1 for the cathode, and labeled 2 for the anode) is shown as filling the entire volume (and is labeled as number 3 in FIG. 1). The cathode is actually continuous, although the figure shows it as a series of circles (a result of the calculations, and not what is physically there).

Each distribution of electric field intensity represents a different distance between the electrodes, which are the anode (labeled 2) and the cathode (labeled 1 in FIG. 1). These different distances are labeled as 30, 40, and 50 in FIG. 1.

In each of the three distributions of electric field intensity, the length of the vector is proportional to the magnitude of the electric field intensity. The directions of the vector of the electric field intensity is shown by a circle at the end of each line. The direction of the electric field intensity points from anode (2) to cathode (1).

The electric field intensity distribution has a region of volume wherein the electric field intensity is directly perpendicular to the electrode (labeled 4). There is no tangential electric field, consistent with classical electrostatics.

In addition, the electric field intensity distribution in each of the distributions within FIG. 1 shows a high electric field intensity region (labeled 5), an intermediate electric field intensity region (labeled 6) and a low electric field intensity region (labeled 7). For clarity, these differences in magnitude of the electric field distribution is only labeled in the bottom subfigure, but range of magnitudes exist in all cases.

It can be seen in FIG. 1, that despite the differences of the distance between the two electrodes, that there is for such wires or thin rods, a clear homology between each of the distributions of electric field intensity.

Turning now to FIG. 2. In accordance with the present invention, FIG. 2 shows the electric field intensity, in a cross-section, between a spiral cathode Phusor which is electrically polarized against, and physically located opposite, an anodic wire of platinum. In cross-section, the Phusor is represented as only its thickness, and thus, the true more complex structure is only approximated.

Attention is directed to the fact that, again, three distributions are shown in FIG. 2, with each representing a different distance between the electrodes. In FIG. 2, these different distances result from the different sizes of the cathode spiral. These different distances are labeled as 60, 70, and 80 in FIG. 2.

Here, as in FIG. 1, the three electric field intensity distributions are shown in two dimensions, in a plane located perpendicular to the direction of the electrodes (labeled 10 for the cathode, and labeled 2 for the anode) which are mainly oriented in a direction coming out of the figure. However, in these cases, unlike FIG. 1, the simple cathode wire, or thin rod, is replaced by a distributed cathode which is in the shape of a circle, or curved spiral (and labeled 10, 11, 12 in FIG. 2). The cathodes are shown (labeled 10, 11, and 12 in the three distributions presented in the three subfigures).

In FIG. 2, these electrodes are an anode (labeled 2) and the spiral, or circular, cathode (labeled 10, 11, and 12 in the three subfigures in Figure, each distinguished by different distances between the electrodes). Because of the 2-dimensional view of FIG. 2, the spiral, or curved, cathode structure, appear as a circle.

The anode is shown (labeled 2 in FIG. 2). The solution in which the electrodes are immersed is shown (and labeled as 3) in each of the subfigures which show the distribution of the electric field intensity in two dimensions for different distances between the electrodes.

In FIG. 2, in each of the subfigures, there are three regions of electric field intensity. The distributions revealed include a high electric field intensity region (labeled 25) and an intermediate electric field intensity region (labeled 26) and a low electric field intensity region (labeled 27). For clarity, these differences in magnitude of the electric field distribution is only labeled in the upper left subfigure, but range of magnitudes exist in all cases.

In FIG. 2, again there are regions near the cathode where the electric field intensity is completely normal (perpendicular) to the cathode (labeled 110). However, what is different, and novel in this case, is the presence of an electric field intensity within the metal, creating a flux of isotopic hydrogen within, and through, the electrode.

In contrast to FIG. 1, in Figure there does occur an entirely different distribution of the electric field intensity. The shape of the structure effects the outcome as much as the material, which is the characteristic of a metamaterial. This is the direct result of the structure of the cathode in this invention, and a direct result of the cathodes planned location within this apparatus, to create a novel process, and thereby a useful invention.

The result of the structure of the cathode, and the cathode's planned location within this apparatus, is that it does create an electric field intensity (labeled 120) within the electrode. This intra-material, intraelectrode, electric field intensity drives the hydrogen, deuterium, or other isotopic fuel, through the material. That driving can then produce the desired reactions. This can be seen in the volume (area, in the 2-dimensional representation of FIG. 2) subtended by the angle labeled 100.

FIG. 2, in comparison to FIG. 1, reveals there are important differences between the electrostatic distributions produced by the two arrangements of wire-wire versus wire-Phusor (shown in FIG. 1). A very distinguishing feature of the arrangement of FIG. 2 over FIG. 1 is the very large asymmetric large electric field intensity at the front of the Phusor (facing the anode). The result is a clear deuteron flux through that portion of the cathode. This does not characterize the two wire situation where the electrical field intensity around the cathode appears to result in the absence of such intra-cathodic deuteron flux within the loaded palladium metallic lattice.

The present invention teaches why Phusors, with their helicies (4), and other metastructures, have relatively good success as LANR cathodes in high impedance solution systems. This analysis of the electrostatic field suggests that both loading flux of deuterons and deuteron flux within the loaded palladium are key components to successful LANR results. Furthermore, with respect to an operating LANR system, both deuteron flows can be increased by controlling the stereoconstellation (metastructure) of the electrode system. This understanding is of particular great interest because LANR structure, and its stereoconstellation to the anode, effect the focal point of the desired reactions. The electrode shape effects outcome, and that Phusors can be made into metamaterials, with structure now supplementing material, nuclear issues, engineering, and electrochemistry. This will be a major part of the ultimate design of future, more successful, LANR materials and devices.

From a material nuclear engineering point of view, geometry and location of electrodes are now shown to play a very significant role in successful LANR experiments, because the organization between, and stereo-constellation of, the electrodes is a major factor in generating non-equilibrium deuteron flux and successful LANR reactions.

In accordance with the important feature of the present invention, there is shown in FIG. 2 versus FIG. 1, the critical difference between the two types of systems; the conventional and the present invention. These figures clearly demonstrates the electrostatic differences between the wire-wire and wire-cylinder or wire-spiral systems. The result is a non-isotropic distribution of electric field at the cathode producing flux of the loaded deuterons within the cathode for the wire-Phusor system, unlike the wire-wire system. This has been heralded by an asymmetric bubbling on the surface of the cathode (reported in ref. 4).

This present investigation has revealed that a direct, loading, electric field intensity results in those portions of the cylinder which are closest to the wire; this extends over a solid angle over a two dimensional angle of approximately ˜45°-130°, depending on many factors of the Phusor geometry and precise inter-electrode distance.

As discussed below, the geometric structure of the Phusor alters the distribution of the electric field so that the portion of the Phusor vicinal to the anode has much higher electric field intensity. It is a dramatic comparison, with a unique electric field distribution, and rare resultant asymmetric bubbling, and the presence of more successful lattice assisted nuclear reactions.

This important difference between the two types of systems, selectively shown in FIG. 2 versus FIG. 1, is a distinguishing factor between successful and non-successful LANR experiments. The presence of such a hydrogen flux, such as deuteron flux in this case, has great implication for experimental and research designs, both in the palladium loading (4, 31-34), in monitoring that loading, and in the likelihood of achieving some of the more desired products. The result, demonstrating the differences between the wire-wire and wire-cylinder systems is shown in FIG. 2. This result, with its unique electric field intensity distribution, maybe the origin of what has been observed (4). The geometric structure of the Phusor alters the distribution of the electric field so that the portion of the Phusor vicinal to the anode has much higher electric field intensity.

The calculated, relatively very large, asymmetric large electric field intensity at the front of the Phusor (facing the anode), suggesting deuteron flux through that portion of the cathode, has been seen. This was experimentally observed and reported, and openly demonstrated at ICCF-10 (4, 30) that observations of spiral Pd cathode undergoing electrolysis in this system exhibits unique behavior. After careful preparation, the resulting large applied electric field intensities produce deuteron flux through hydrided metal heralded by the asymmetric bubbling, and characterized by a large peak of the optimal operating point manifold. The Pt anode is to the left of the cathode, and is not shown.

This is unique behavior, here viewed through the vertical axis half way up the Phusor. Note the distribution and symmetry shown in FIG. 2, compared to two wires (FIG. 1) secondary to the electric field distribution.

This difference in electric field distributions between the wire-wire and wire-Phusor or cylinder system may account for the variations between, and relative success, of the Phusor system. In this case of the wire-Phusor system, there is an unusual electric field distribution resulting in loading and intra-palladium flux.

Looked at another way, this invention is a novel process for producing flow of isotopic fuel through a material is unique. It requires enclosing a volume of solution, such as deuterium oxide (D2O), in which are immersed two electrodes, anode and cathode, ensuring that the solution will provide the isotopic fuel (hydrogen or deuterons) and load the cathode. This is then followed by providing a wire or rod anode which does not corrode, such as platinum. As the counterelectrode, success in the process requires providing said material as a cathode of helical shape, long axis parallel to the anode, of palladium, able to load with the isotopic fuel to support intraelectrode flux of said isotopic fuel. In the preferred embodiment there is a ratio of diameters of between the full width of the helical wound cathode and the anode of 25, although this can range from 4 to 1000. The flux is driven by powering the system by an applied electric field intensity between the electrodes, able to produce loading and intraelectrode flux of the isotopic fuel, with a potential in the range of 4 to 4000 volts, while maintaining a distance between the electrodes, adjusted to create direct loading, and over each portion of the helical cathode, closest to the anode, over a two dimensional angle of 45 to 130 degrees.

The preferred embodiment uses a direct, loading, electric field intensity results in those portions of the cylinder which are closest to the wire; this extends over a solid angle over a two dimensional angle of circa 45°-1300 degrees.

By use of this invention, core LANR systems, such as shown in FIG. 2, can be of great utility by providing heat for cold environments, and for making electricity in all.

A designed container making the holding, preparing, and running of the product convenient, and simple in the preferred embodiment. The preferred embodiment is used to generate reactions through the flux in the loaded material, but as a variation it could also be used in a system where there is removal of the hydrogen (or D2) which is generated as a waste product, so that it can be recycled in a fuel cell to make electricity.

In one embodiment, there could be a mechanical separator to separate gases generated at said anode and cathode. That separator could be connected to a hood to catch said generated cases. In one embodiment there would be a mechanical protrusion on a slidable gas-catching hood to secure hood position during slide-up. In addition, in some embodiments there could be means to maintain levels of the solution, including a reservoir of heavy water (in the case of deuterons loaded into palladium, for example) with associated pump, fittings, supply line, valves to maintain heavy water levels and purge the fuel cell line, if a fuel cell is used to generate electricity.

As an alternative, a wire or rod anode of gold can be used. A helical cathode of nickel can be used, if light water is used as the solution, with hydrogen as the isotopic fuel which is loaded.

This invention has great utility because it can still maximize the flux of isotopic hydrogen (deuterons) through a hydrogen (or deuterium) loaded material.

In the preferred embodiment, palladium is used with heavy water as the solution used to provide the deuterons for loading and flux through the palladium. In other embodiments, the loaded material is a member of the group consisting of Group VIII, Group IVb and Vb, and rare earth elements, including palladium, nickel, titanium, nickel, cerium, lanthanum, niobium, tantalum, thorium, vanadium, zirconium, and their alloys and composites, and those materials which are “preloaded” with protons or deuterons already in place, including PdDx and TiDx.

As another variation, the shape can be more complicated than a simple helix, by variation of the radius of the helix. And as an alternative, the helix can be modeled by taking a portion of it, using a bent cathode shaped to produce a similar result in the form of a curve which part of a helix, spiral, circle, or similar shape. Furthermore, the cathode could be fashioned to have four leads so as to enable an in situ four terminal conductivity measurement and to provide for means provide a second applied electric field.

As a variation of the present invention, the solution can be a gas containing the isotope to loaded. The system could be enhanced by pressure from D2, and by use of prepared preloaded alloys such as PdDx, or TiDx.

In an alternate embodiment, the solution is one of the group consisting of light water, heavy water, heavy-water doped light water, a sol-gel containing said isotopic fuel, and a codepositional solute containing said material in which the isotopic fuel flows. The codepositional solute creates a solution which contains ions of the material to enable said codeposition of said material. When the solution is a sol-gel, then the solution has properties of both solution and gel (prepared using components such as glycerolized deuterated gelatin), which are used to improve handling.

As an alternative, gas containing the isotope to be loaded, filled by external pressure can be used to augment, or even replace the solution.

In one embodiment of the present invention, feedback and human control are used to control the output by controlling the input electrical current, and inter-electrode distances.

This is based upon IR visualization of the surface of the cathode, as a noninvasive means to measure temperature and loading.

In another embodiment of the present invention, there are included illumination sources, in the near infrared or visible region—to increase the loading rate at the cathode. Such a cell would be fashioned to include an external light source or laser, with accompanying holding bracket to hold, and position, the light source or laser, so as to illuminate the cathode

Furthermore, computation systems can be added to detect, maintain, and thereby control, the peak heat production point to maximize the amount of heat. In the case of other products, similar control would be used.

The original specification, accompanied by the figures of said specification, clarify and define these matters to one skilled in the art by providing a complete description.

Modification of the invention herein disclosed will occur to persons skilled in the art. It is understood that the specific embodiments of the invention shown and described are but illustrative and that various modifications can be made therein without departing from the scope and spirit of this invention, and all such modifications are deemed to be within the scope of the invention as defined by the appended claims.

### A Machine for Producing Flow of Isotopic Fuel through a Material

### SUMMARY OF INVENTION

In summary,

A machine for producing flow of isotopic fuel through a material comprising: a wire or rod anode which does not corrode, such as platinum, a solution, such as deuterium oxide (D2O), in which are immersed the electrodes, anode and cathode, which will provide the isotopic fuel (hydrogen or deuterons) and load the cathode, a power supply capable of apply an electric field intensity between the electrodes, able to produce loading and intraelectrode flux of the isotopic fuel, with a potential in the range of 4 to 4000 volts, a cathode of helical shape, long axis parallel to the anode, of palladium, able to load with the isotopic fuel to support intraelectrode flux of said isotopic fuel, a ratio of diameters between the full width of the helical wound cathode and the anode of 4 to 1000, a distance between the electrodes, adjusted to create direct loading, and over each portion of the helical cathode, closest to the anode, over a two dimensional angle of 45 to 130 degrees.

What is claimed is:

1. A machine for producing flow of isotopic fuel through a material comprising:
a wire or rod anode which does not corrode, such as platinum;
a solution, including deuterium oxide (D2O), in which are immersed the electrodes, anode and cathode, which will provide the isotopic fuel (hydrogen or deuterons) and load the cathode;
a power supply capable of applying an electric field intensity between the electrodes, able to produce loading and intraelectrode flux of the isotopic fuel, with a potential in the range of 4 to 4000 volts;
said material being a cathode of helical shape, long axis parallel to the anode, of palladium, able to load with the isotopic fuel to support intraelectrode flux of said isotopic fuel;
a ratio of diameters between the full width of the helical wound cathode and the anode of 4 to 1000;
a distance between the electrodes, adjusted to create direct loading, and over each portion of the helical cathode, closest to the anode, over a two dimensional angle of 45 to 130 degrees; and

2. A machine as in claim 1 which also has an illumination sources, in the near infrared or visible region—to increase loading the cathode.

3. A machine as in claim 1 which also has an mechanical separator to separate gases generated at said anode and cathode.

4. A machine as in claim 1 which also has a material which is a member of the group consisting of Group VIII, Group IV_{b} and V_{b}, and rare earth elements, including palladium, nickel, titanium, nickel, cerium, lanthanum, niobium, tantalum, thorium, vanadium, zirconium, and their alloys and composites, and those materials which are “preloaded” with protons or deuterons already in place, including PdDₓ and TiDₓ.

5. A machine as in claim 1 which said solution contains ions of the material to enable codeposition of said material.

6. A machine as in claim 1 which also has said cathode of a shape involving a curve which part of a helix.

7. A machine for producing flow of isotopic fuel through a material comprising:
a wire or rod anode which does not corrode, such as platinum;
a solution, such as water, in which are immersed the electrodes, anode and cathode, which will provide the isotopic fuel (hydrogen or deuterons) and load the cathode;
a power supply capable of applying an electric field intensity between the electrodes, able to produce loading and intraelectrode flux of the isotopic fuel, with a potential in the range of 4 to 4000 volts;
a cathode of helical shape, long axis parallel to the anode, of nickel, able to load with the isotopic fuel to support intraelectrode flux of said isotopic fuel;
a ratio of diameters between the full width of the helical wound cathode and the anode of 4 to 1000;
a distance between the electrodes, adjusted to create direct loading, and over each portion of the helical cathode, closest to the anode, over a two dimensional angle of 45 to 130 degrees.

8. A machine as in claim 7 which also has an illumination sources, in the near infrared or visible region—to increase loading the cathode.

9. A machine as in claim 7 which also has an mechanical separator to separate gases generated at said anode and cathode.

10. A machine as in claim 7 which also has a material which is a member of the group consisting of Group VIII, Group IV_{b} and V_{b}, and rare earth elements, including palladium, nickel, titanium, nickel, cerium, lanthanum, niobium, tantalum, thorium, vanadium, zirconium, and their alloys and composites, and those materials which are “preloaded” with protons or deuterons already in place, including PdDₓ and TiDₓ.

11. A machine as in claim 7 wherein said solution is one of the group consisting of light water, heavy water, heavy-water doped light water, a sol-gel containing said isotopic fuel, and a codepositional solute containing said material in which the isotopic fuel flows.

12. A machine as in claim 7 which also has said cathode of a shape which is a member of the group consisting of a curve which part of a helix, or part of a spiral, or part of a circle, or similar shape.

13. A machine as in claim 7 wherein said solution is replaced by said isotopic fuel in a gas phase.

14. A process for producing flow of isotopic fuel through a material comprising:
enclosing a volume of solution, such as deuterium oxide (D2O), in which are immersed two electrodes, anode and cathode,
ensuring that the solution will provide the isotopic fuel (hydrogen or deuterons) and load the cathode;
providing a wire or rod anode which does not corrode, such as platinum;
providing said material as a cathode of helical shape, long axis parallel to the anode, of palladium, able to load with the isotopic fuel to support intraelectrode flux of said isotopic fuel;
using a ratio of diameters between the full width of the helical wound cathode and the anode of 4 to 1000;
powering the system by an applied electric field intensity between the electrodes, able to produce loading and intraelectrode flux of the isotopic fuel, with a potential in the range of 4 to 4000 volts;
maintaining a distance between the electrodes, adjusted to create direct loading, and over each portion of the helical cathode, closest to the anode, over a two dimensional angle of 45 to 130 degrees.

15. A process as in claim 14 which also has an external laser holding bracket to hold, position, an laser to illuminate the cathode

16. A process as in claim 14 which also has an mechanical protrusion on the slidable gas-catching hood to secure hood position during slide-up.

17. A process as in claim 14 which also has said fashioned with four leads so as to enable an in situ four terminal conductivity measurement and to provide for means provide a second applied electric field.

18. A process as in claim 14 which also has a reservoir of heavy water and pump, fittings, supply line, valves to maintain heavy water levels and purge the fuel cell line.

19. A process as in claim 14 where said metal loaded with hydrogen is palladium and the hydrogen is a deuteron.

20. A process as in claim 14 where said metal loaded is a member of the group consisting of Group VIII, Group IV_{b} and V_{b}, and rare earth elements, including palladium, nickel, titanium, nickel, cerium, lanthanum, niobium, tantalum, thorium, vanadium, zirconium, and their alloys and composites, and those materials which are “preloaded” with protons or deuterons already in place, including PdDₓ and TiDₓ.
